(19) United States
(12) Patent Application Publication
(10) Pub. No.: US 2009/0004234 A1
(43) Pub. Date: Jan. 1, 2009

(54) DOSING DEVICE

(76) Inventors: Arnd KESSLER, Monheim-Baumberg (DE); Ingo HARDACKER, Hamminkeln (DE); Federica BERARDO, Koln (DE)

Correspondence Address: PAUL & PAUL, 2000 MARKET STREET, Suite 2900, PHILADELPHIA, PA, 19103-3229, US

(21) Appl. No.: 11/955,707

(22) Filed: Dec. 13, 2007

Related U.S. Application Data
(63) Continuation of application No. PCT/EP2006/005455, filed on Jun. 8, 2006.

(30) Foreign Application Priority Data
Jun. 15, 2005 (DE) 102005027660.1

(51) Int. Cl. C11D 17/00; A01N 25/10

(52) U.S. Cl. 424/409; 510/445; 510/295; 510/224

(57) ABSTRACT

A dosing device for dosing active substances in washing or cleaning processes, encompassing a container and a) a first active substance composition, present in said container, that contains at least one carrier material and at least one active substance; and b) a second active substance composition, present in said container, that likewise contains at least one carrier material and at least one active substance, but differs in terms of at least one of its ingredients from the first active substance composition, wherein the carrier material in at least one active substance composition is water-insoluble, is suitable for the release of different active substances and is notable for an improved release profile as compared with conventional dosing devices.

### CROSS-REFERENCE TO RELATED APPLICATIONS

This application is a continuation under 35 U.S.C. Section 365(c) and 35 U.S.C. Section 120 of International Application No. PCT/EP2006/005455, filed Jun. 8, 2006. This application also claims priority under 35 U.S.C. Section 119 of German Patent Application No. DE 10 2005 027 660.1, filed Jun. 15, 2005. Both the International Application and the German Application are incorporated herein by reference in their entireties.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

The present invention is in the field of dosing devices for substances having washing or cleaning activity; the present invention relates, in particular, to dosing devices for simultaneous dosing of different substances having washing or cleaning activity.

In washing or cleaning processes, additional additives and adjuvants are generally used in addition to the actual active substances having washing or cleaning activity, such as, for example, the detergency builders, soaps, or surfactants. The most common adjuvants are, in addition to the fragrances, the corrosion inhibitors for protecting silver or glassware, clear rinsing agents, or bleach activators for automatic dishwashing; and ironing adjuvants, optical brighteners, or antistatic agents for automatic textile cleaning.

These additives or adjuvants can be present as an integral constituent of the washing or cleaning agent that is used, but said cleaning agents can also be added in the form of a special washing agent or special cleaning agent. A further possibility for dosing these adjuvants are the commercially available multiple dosing devices, for example, for scenting automatic dishwashers. The purpose of these dishwasher deodorizers is to eliminate or decrease unpleasant odors in the automatic dishwasher that can result, for example, from the storage of dirty dishes, or washing-bath odors after the cleaning process is complete.

These deodorizers can be presented in very different ways. In this context, it is desirable for the consumer to obtain an item for the deodorization of automatic dishwashers or other enclosed spaces that exhibits an intense product scent when made available, which not only ensures product identification but at the same time conveys an impression of great effectiveness, and which then ensures, in the course of its service life, a maximally reliable release of constant quantities of fragrance. These deodorizers should furthermore achieve their effect independently of external factors such as (atmospheric) humidity, temperature, or alkalinity. A number of different deodorizers for automatic dishwashers are described in the existing art.

(2) Description of Related Art, Including Information Disclosed Under 37 C.F.R. Sections 1.97 and 1.98

A scent delivery system of the species is known from WO 02/09779 A1 (Procter & Gamble). This known scent delivery system comprises a container in which a plurality of small particles loaded with fragrances is received. The container is equipped with a plurality of openings whose size is dimensioned such that the small particles cannot emerge through the openings. On the other hand, the openings are dimensioned so that an emission of the fragrances of the particles out of the receiving space of the container is possible.

Deodorizers for use in clothes dryers are also evident from the existing art.

For example, U.S. Pat. No. 6,235,705 (Bath & Body Works) describes a product for scenting in a clothes dryer, which product is made up of fragrance-containing plastic beads in a mesh bag. Scenting of the beads takes place while they are being manufactured, at elevated temperature.

### BRIEF SUMMARY OF THE INVENTION

It was the object of the present invention to make available dosing devices for active substances having washing or cleaning activity that are suitable for simultaneous release of different active substances and are notable, as compared with conventional dosing devices, for an improved release profile of said active substances. The intention, in particular, was for the duration of the active substance release to be extended, and at the same time to achieve uniform release of the active substance.

To achieve this object, a dosing device was made available having two different active substance compositions, at least one of which comprises a water-insoluble carrier material.

A first subject of the present Application is, therefore, a dosing device for dosing active substances in washing or cleaning processes, encompassing a container and
a) a first active substance composition, present in said container, that contains at least one carrier material and at least one active substance; and
b) a second active substance composition, present in said container, that likewise contains at least one carrier material and at least one active substance, but differs in terms of at least one of its ingredients from the first active substance composition,
   wherein the carrier material in at least one active substance composition is water-insoluble.

The dosing device according to the present invention is suitable for dosing a plurality of substances having washing or cleaning activity. This dosing device is suitable, in particular, for separate presentation and dosing of different active substance compositions. In a preferred embodiment, the dosing device according to the present invention is suitable, in particular, for multiple dosing of said active substance compositions.

### BRIEF DESCRIPTION OF THE SEVERAL VIEWS OF THE DRAWING(S)

Not Applicable

### DETAILED DESCRIPTION OF THE INVENTION

In a preferred embodiment, the dosing device according to the present invention is suitable for multiple dosing of the active substances contained in it. In other words, the dosing device according to the present invention releases said active substances by preference over a period of time that is equal to a multiple of the period of time of one washing or cleaning process. In a preferred embodiment, the dosing device according to the present invention is suitable for dosing one or more active substances in 10 to 100, by preference 20 to 90, and, in particular, 30 to 80 cleaning cycles of an automatic dishwasher, a textile washing machine, or a textile dryer.

This kind of long-lasting release of the active substances can be achieved, for example, by the fact that the active substances used are dissolution-delayed by appropriate presentation, in which context, in particular, the selection of carrier material and the processing of the carrier material and active substance to yield the final active substance composition influence the release kinetics of the active substance. A further possibility for delaying release of the active substances or stretching it out in time is based on the physical conformation of the container.

In a preferred embodiment, the wall delimiting the container externally comprises a plurality of openings. Said openings enable, on the one hand, the emergence of volatile active substances such as, for example, the fragrances described below, and, on the other hand, enable the entry of aqueous washing baths, to the extent the dosing devices according to the present invention come into contact with such washing or cleaning baths during their use in the washing or cleaning processes.

Dosing devices wherein the container comprises at least two receiving chambers separated from one another, each of which is filled with at least one active substance composition, said active substance compositions differing in terms of at least one of their ingredients, are particularly preferred according to the present invention.

In a further preferred embodiment, the dosing device comprises a mounting apparatus.

The dosing devices according to the present invention can, of course, also encompass more than the two aforesaid active substance preparations. Dosing devices having three, four, five, or more active substance preparations, which differ from one another in terms of at least one of their ingredients, are preferred according to the present invention.

In addition to the container described above, the dosing devices according to the present invention further encompass one or more carrier materials, at least one of which is water-insoluble.

Textile materials or polymers are used with particular preference as water-insoluble carrier materials. A dosing device wherein the container is produced from a water-insoluble material, by preference from a textile material or a polymer or a polymer mixture, is preferred according to the present invention.

The polymers used, in particular, water-insoluble polymers, are by preference synthetic polymers. Dosing devices according to the present invention, wherein at least one of the carrier materials is a polymer material, by preference, a substance from the group encompassing ethylene-vinyl acetate copolymers, low- or high-density polyethylene (LDPE, HDPE) or mixtures thereof, polypropylene, polyethylene-polypropylene copolymers, polyether-polyamide block copolymers, styrene-butadiene (block) copolymers, styrene-isoprene (block) copolymers, styrene-ethylene-butylene copolymers, acrylonitrile-butadiene-styrene copolymers, acrylonitrile-butadiene copolymers, polyether esters, polyisobutene, polyisoprene, ethylene-ethyl acrylate copolymers, polyamides, polycarbonate, polyesters, polyacrylonitrile, polymethyl methacrylate, polyurethanes, polyvinyl alcohols, are preferred according to the present invention.

“Polyethylene” (PE) is a collective term for the polymers, belonging to the polyolefins, having groups of the CH₂—CH₂ type as a characteristic basic unit of the polymer chain.

“Polypropylene” (PP) is the term for thermoplastic polymers of propylene having the general formula —(CH₂—CH[CH₃])ₙ—.

“Polyether” is a comprehensive term in the field of macromolecular chemistry for polymers whose organic repeating units are held together by ether (C—O—C) functionalities. According to this definition, a large number of structurally very different polymers belong to the polyethers, e.g., the polyalkylene glycols (polyethylene glycols, polypropylene glycols, and polyepichlorohydrins) as polymers of 1,2-epoxides, epoxy resins, polytetrahydrofurans (polytetramethylene glycols), polyoxethanes, polyphenylene ethers (cf. polyaryl ethers), or polyether ether ketones (cf. polyether ketones). Polymers having lateral ether groups, such as, among others, the cellulose ethers, starch ethers, and vinyl ether polymers, are not counted among the polyethers.

Also included in the group of the polyethers are functionalized polyethers, e.g., compounds having a polyether structure that additionally carry, attached laterally onto their main chains, other functional groups such as, for example, carboxy, epoxy, allyl, or amino groups, etc. Block copolymers of polyethers and polyamides (polyether amides or polyether block amides, PEBA) can be used in many ways.

“Polyamides” (PA) refers to polymers whose basic modules are held together by amide bonds (—NH—CO—). Naturally occurring polyamides are peptides, polypeptides, and proteins (e.g., albumen, wool, silk). The synthetic polyamides are, with few exceptions, thermoplastic chain-type polymers.

In addition to the homopolyamides, some copolyamides have also acquired significance. A qualitative and quantitative indication of the composition is usual for these, e.g., PA 66/6 (80:20) for polyamides manufactured from 1,6-hexanediamine, adipic acid, and ε-caprolactam at a molar ratio of 80:80:20.

Because of their particular properties, polyamides that contain exclusively aromatic radicals (e.g., those made of p-phenylenediamine and terephthalic acid) are referred to by the species definition “aramids” or polyaramids (e.g., Nomex®).

The polyamide grades most often used (cf. also PA 6 and PA 66) are made of unbranched chains having average molar weights from 15,000 to 50,000 g/mol. They are partially crystalline in the solid state and have degrees of crystallization from 30 to 60%. One exception is represented by polyamides comprising modules having side chains, or copolyamides made of greatly different components, which are largely amorphous. In contrast to the generally milky/opaque, partially crystalline polyamides, the latter are almost crystal-clear. The softening temperature of the most common homopolyamides is between 200 and 260° C. (PA 6: 215-220° C.; PA 66: 255-260° C.).

“Polyester” is the general term for polymers whose basic modules are held together by ester bonds (—CO—O—). The homopolyesters can be divided, based on their chemical composition, into two groups: the hydroxycarboxylic acid types (AB polyesters) and the dihydroxydicarboxylic acid types (AA-BB polyesters). The former are manufactured from only a single monomer, e.g., by polycondensation of an ω-hydroxycarboxylic acid 1, or by ring-opening polymerization of cyclic esters (lactones) 2.

Branched and crosslinked polyesters are obtained upon polycondensation of trivalent or polyvalent alcohols with polyfunctional carboxylic acids. The polycarbonates (polyesters of carbonic acid) are generally also included among the polyesters.

AB-type polyesters (I) are, among others, polyglycolic acids, polylactic acids, polyhydroxybutyric acid [poly(3-hydroxybutyric acid)], poly(ε-caprolactones), and polyhydroxybenzoic acids.

Purely aliphatic AA-BB-type polyesters (II) are polycondensates of aliphatic diols and dicarboxylic acids, which are used, inter alia, as products having terminal hydroxy groups (as polydiols) for the manufacture of polyester polyurethanes (e.g., polytetramethylene adipate). The AA-BB-type polyesters with the greatest industrial significance in terms of volume are those made from aliphatic diols and aromatic dicarboxylic acids, in particular, the polyalkylene terephthalates, with polyethylene terephthalate (PET), polybutylene terephthalate (PBT), and poly(1,4-cyclohexanedimethylene terephthalates) (PCDT) as the most important representatives. By concurrently using other aromatic dicarboxylic acids (e.g., isophthalic acid) or utilizing diol mixtures in the context of polycondensation, these types of polyester can be greatly varied in terms of properties and adapted to different fields of application.

Purely aromatic polyesters are the polyarylates, which include poly(4-hydroxybenzoic acid) among others. In addition to the saturated polyesters already mentioned, it is also possible to manufacture unsaturated polyesters from unsaturated dicarboxylic acids; these have acquired technical significance as polyester resins, in particular, as unsaturated polyester (UP) resins.

“Polyurethanes” (PUR) refer to polymers in whose macromolecules the repeating units are linked by urethane groups —NH—CO—O—. Polyurethanes are generally obtained by polyaddition of divalent or polyvalent alcohols and isocyanates.

Depending on the starting materials selected and their stoichiometric ratio, polyurethanes can thus be produced with very different mechanical properties, and can be used as constituents of adhesives and coatings (polyurethane resins), as ionomers, as a thermoplastic material for bearing parts, rollers, tires, rolling elements, and as elastomers of greater or lesser hardness in fiber form (elastofibers, abbreviated PUE for these elastan or spandex fibers), or as polyether or polyester urethane rubber (EU or AU).

“Polyvinyl alcohol” (PVAL, occasionally also PVOH) is the term for polymers of the general structure

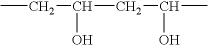

that can also contain small proportions (approximately 2%) of structural units of the

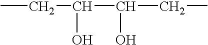

type.

Commercially available polyvinyl alcohols are offered as yellowish-white powders or granulates having degrees of polymerization in the range from approximately 100 to 2,500 (molecular weights from approximately 4,000 to 100,000 g/mol). Polyvinyl alcohols are characterized by manufacturers by indicating the degree of polymerization of the initial polymers, the degree of hydrolysis, the saponification value, or the solution viscosity.

Depending on their degree of hydrolysis, polyvinyl alcohols are soluble in water and in a few highly polar organic solvents (formamide, dimethylformamide, dimethylsulfoxide); they are not attacked by (chlorinated) hydrocarbons, esters, fats, and oils. Polyvinyl alcohols are classified as toxicologically harmless and are at least partly biodegradable. The water solubility can be decreased by post-treatment with aldehydes (acetalization), by complexing with Ni or Cu salts, or by treatment with dichromates, boric acid, or borax. Coatings made of polyvinyl alcohol are largely impenetrable to gases such as oxygen, nitrogen, helium, hydrogen, and carbon dioxide, but allow water vapor to pass.

Polyvinyl alcohols of a specific molecular-weight range are preferably used as carrier materials, it being preferred according to the present invention that the water-soluble or water-dispersible container encompass a polyvinyl alcohol whose molecular weight is in the range from 10,000 to 100,000 gmol⁻¹, by preference from 11,000 to 90,000 gmol⁻¹, particularly preferably from 12,000 to 80,000 gmol⁻¹, and, in particular, from 13,000 to 70,000 gmol⁻¹.

In a particularly preferred embodiment of the present invention, the polymeric carrier material of the particles is made at least in part of ethylene-vinyl acetate copolymer. A further preferred subject of the present Application is therefore a dosing device wherein a polymeric carrier material contains at least 10 wt %, by preference at least 30 wt %, particularly preferably at least 70 wt % ethylene-vinyl acetate copolymer, by preference is manufactured entirely from ethylene-vinyl acetate copolymer.

“Ethylene-vinyl acetate copolymers” is the term for copolymers of ethylene and vinyl acetate. This polymer is manufactured essentially using a method comparable to the manufacture of low-density polyethylene (LDPE). With an increasing proportion of vinyl acetate, the crystallinity of the polyethylene is interrupted and the melting and softening points, and the hardness, of the resulting products are thereby reduced. The vinyl acetate furthermore makes the copolymer more polar, thus improving its adhesion to polar substrates.

The ethylene-vinyl acetate copolymers described above are widely available commercially, for example, under the trademark Elvax® (DuPont). Polyvinyl alcohols that are particularly suitable in the context of the present invention are, for example, Elvax® 265, Elvax® 240, Elvax® 205 W, Elvax®200 W, and Elvax® 360.

Some particularly suitable copolymers and their physical properties are evident from TABLE 1 below:

| | Wt % Vinyl Acetate | |
|---|---|---|
| Product Name | (based on total weight) | Melting Point |
| Elvax ® 40W | 40 | 47° C. |
| Elvax ® 150 | 33 | 63° C. |
| Elvax ® 265 | 28 | 75° C. |
| Elvax ® 240 | 28 | 74° C. |
| Elvax ® 205 W | 28 | 72° C. |
| Elvax ® 200 W | 28 | 71° C. |
| Elvax ® 360 | 25 | 78° C. |
| Elvax ® 460 | 18 | 88° C. |
| Elvax ® 660 | 12 | 96° C. |
| Elvax ® 760 | 9 | 100° C. |

Dosing devices in which ethylene-vinyl acetate copolymer is used as a polymer carrier material, and said copolymer contains 5 to 50 wt % vinyl acetate, by preference, 10 to 40 wt % vinyl acetate, and, in particular, 20 to 30 wt % vinyl acetate, based in each case on the total weight of the copolymer, are particularly preferred in the context of the present invention, especially in the sector of scenting the interiors of automatic dishwashers.

In a further preferred embodiment, at least one of the active substance compositions of the dosing device contains a polyether-ester-amide (PEEA) polymer of the general formula HO[C(O)—PA—C(O)—O—PE—O]ₙH. Dosing devices according to the present invention, wherein at least one of the active substance compositions contains a polyether-ester-amide (PEEA) polymer of the general formula HO[C(O)—PA—C(O)—O—PE—O]ₙH, in which PA denotes a polyamide group, PE a polyether group, and n a whole number, are particularly preferred.

Corresponding PEEA polymers are obtainable, for example, by copolymerization of the polyamide of a dicarboxylic acid, which polyamide carries a terminal acid group and has an average molecular weight between 300 and 15,000, with a linear or branched aliphatic polyalkylene glycol that carries a terminal hydroxyl group and has an average molecular weight between 200 and 6,000. Copolymerization is accomplished, by preference, in a melt at temperatures between 100 and 400° C.

Corresponding PEEA polymers are commercially obtainable under the designation Pebax®. Whereas the aforesaid PEEA polymers are suitable in principle as an ingredient of the active substance compositions dispensed according to the present invention, those active substance compositions that can accommodate at least 2.3 times, by preference 5 times, their own weight in fragrances are particularly preferred. Suitable PEEA polymers are, for example, Pebax® 2533, Pebax® 3533, or Pebax® 4033.

In a further preferred embodiment, at least one of the active substance compositions is an active-substance-containing gel. Gels encompassing
a) 70 to 98 wt % of at least one active substances, by preference a fragrance, and
b) 2 to 30 wt % of a polyether-ester-amide (PEEA) polymer of the general formula HO[C(O)—PA—C(O)—O—PE—O]ₙH in which PA denotes a polyamide group, PE a polyether group, and n a whole number,
   are particularly preferred.

In a further preferred embodiment, the dosing device according to the present invention encompasses activated carbon as a carrier material. “Activated carbon” is understood as black, lightweight, dry, odorless and tasteless powders or granulates of tiny graphite crystals and amorphous carbon, having a porous structure and a very large internal surface area (by preference between 500 and 1,500 m²/g). A distinction is made among powdered activated carbon, granular activated carbon, and, for example, cylindrical shaped activated carbon. Activated carbon can contain up to 25 wt % mineral components. In a particularly preferred embodiment, the activated carbon can function as a fragrance scavenger and is thus simultaneously a carrier material and active substance.

Further suitable carrier materials are the cyclodextrins.

Alternatively or as a supplement to the aforementioned carrier materials, inorganic carrier materials are also preferably used. Dosing devices wherein at least one of the carrier materials is an inorganic carrier material, by preference a silicate, phosphate, or borate, are particularly preferred.

The silicates, phosphates, or borates are present by preference in the form of a glass, particularly preferably in the form of a water-soluble glass. Particularly preferred inorganic carrier materials are, for example, zeolites, by preference acid-modified zeolites.

The aforesaid carrier materials can be used alone or in combination with other carrier materials.

Thermoplastic carrier materials, or carrier materials that deform plastically under the action of the ambient temperatures occurring during use, are particularly preferred in the context of the present Application. The plastic deformation of the carrier materials in the course of one or more uses results in a modification of the carrier material surface, in particular, a modification of the size of the carrier material surface, which in turn has an advantageous effect on the release profile and release kinetics of the active substances having washing or cleaning activity that are contained in the active substance compositions. Dosing devices wherein at least one polymeric carrier material has a melting or softening point between 40 and 125° C., by preference, between 60 and 100° C., particularly preferably, from 70 to 90° C., and, in particular, between 75 and 80° C., are preferred according to the present invention.

The dosing devices according to the present invention are suitable, in particular, for multiple dosing of the active substances contained in them. In order to ensure such multiple dosing over a plurality of washing or cleaning processes, it has proven advantageous to use exclusively water-insoluble carrier materials. These water-insoluble carrier materials furthermore simplify the manufacture of dosing devices according to the present invention. Preferred dosing devices are, therefore, characterized in that all the carrier materials used are water-insoluble.

The active substance compositions can, in principle, assume all aggregate states and/or physical forms achievable as a function of the chemical and physical properties of the carrier materials.

In a first preferred embodiment, at least one of the active substance compositions is present as a gel.

In a further preferred embodiment, at least one of the active substance compositions is present as a solid. Active substance compositions in the form of individual blocks encompassing an entire active substance composition are used with particular preference. Alternatively, the active substance compositions can be present in particulate form; dosing devices in which the carrier material of at least one of the active substance compositions is present in particle form, said particles having, by preference, an average diameter from 0.5 to 20 mm, preferably, from 1 to 10 mm, and, in particular, from 3 to 6 mm, are particularly preferred.

In a further preferred embodiment, the dosing device according to the present invention encompasses at least two active substance compositions, each of which encompasses a water-insoluble carrier material in particle form, said carrier material being present dispersed in a gelled active substance preparation.

Dosing devices according to the present invention that encompass at least one colored active substance composition are particularly preferred. The coloring of at least one of the active substance compositions allows a visual differentiation of said compositions to be achieved, and allows the multiple usability of said different compositions to be illustrated easily. However, the dyes are also furthermore suitable as an indicator, in particular, as a consumption indicator, for the colored active substance compositions.

Preferred dyes, the selection of which will present no difficulty whatsoever to one skilled in the art, possess excellent shelf stability and insensitivity to the other ingredients of the agents and to light, and no pronounced substantivity with respect to the substrates to be treated with the dye-containing agents, such as textiles, glass, ceramics, or plastic dishes, in order not to color them.

In selecting the coloring agent, care must be taken that the coloring agents exhibit excellent shelf stability and insensitivity to light and do not exhibit too great an affinity for glass, ceramics, or plastic dishware. At the same time, it must also be considered when selecting suitable coloring agents that coloring agents have differing levels of stability with respect to oxidation. It is generally the case that water-insoluble coloring agents are more stable with respect to oxidation than water-soluble coloring agents. The concentration of the coloring agent in the washing or cleaning agents varies as a function of solubility and thus also of oxidation sensitivity. For readily water-soluble coloring agents, coloring-agent concentrations in the range of a few 10⁻² to 10⁻³ wt % are typically selected. In the case of the pigment dyes, on the other hand, which are particularly preferred because of their brilliance but are less readily water-soluble, the appropriate concentration of the coloring agent in washing or cleaning agents is typically a few 10⁻³ to 10⁻⁴ wt %.

Coloring agents that can be oxidatively destroyed in the washing process, as well as mixtures thereof with suitable blue dyes, bluing agents, are preferred. It has proven advantageous to use coloring agents that are soluble in water or at room temperature in liquid organic substances. Anionic coloring agents, e.g., anionic nitroso dyes, are suitable, for example.

As a further ingredient, the dosing devices according to the present invention encompass one or more active substances. These active substances are active substances having washing or cleaning activity. Preferred dosing devices according to the present invention are characterized in that at least one of these active substances is selected from the group of the fragrances, fragrance scavengers, dyes, glass corrosion inhibitors, silver protection agents, bleach catalysts, antimicrobial active substances, germicides, fungicides, polymers having washing or cleaning activity, or surfactants.

Individual odorant compounds, e.g., synthetic products of the ester, ether, aldehyde, ketone, alcohol, and hydrocarbon types, can be used as perfume oils or fragrances in the context of the present invention. It is preferred, however, to use mixtures of different odorants that together produce an appealing fragrance note. Such perfume oils can also contain natural odorant mixtures such as those accessible from plant sources, for example, pine, citrus, jasmine, patchouli, rose, or ylang-ylang oil.

In order to be perceptible, an odorant must be volatile; in addition to the nature of the functional groups and the structure of the chemical compound, the molecular weight also plays an important part. Most odorants, for example, possess molar weights of up to approximately 200 dalton, while molar weights of 300 dalton and above represent something of an exception. Because of the differing volatility of odorants, the odor of a perfume or fragrance made up of multiple odorants changes during volatilization, the odor impressions being subdivided into a “top note,” “middle note” or “body,” and “end note” or “dry out.” Because the perception of an odor also depends a great deal on the odor intensity, the top note of a perfume or fragrance is not made up only of highly volatile compounds, while the end note comprises for the most part less-volatile, i.e., adherent odorants. In the compounding of perfumes, more-volatile odorants can, for example, be bound to specific fixatives, thereby preventing them from volatilizing too quickly. In the division below of odorants into “more-volatile” and “adherent” odorants, no statement is therefore made with regard to the odor impression, or as to whether the corresponding odorant is perceived as a top or middle note.

The fragrances can be processed directly, but it may also be advantageous to apply the fragrances onto carriers that ensure a slower scent release for a lasting scent. Cyclodextrins, for example, have proven successful as such carrier materials; the cyclodextrin-perfume complexes can additionally be coated with further adjuvants.

The known ricinoleates, in particular, zinc ricinoleates, are usable as fragrance scavengers. Activated carbon and/or cyclodextrins and/or zeolites, by preference acid-modified zeolites, are also used with particular preference.

Glass corrosion inhibitors prevent the occurrence of clouding, smearing, and scratching, but also iridescence, on the glass surface of automatically washed glasses. Preferred glass corrosion inhibitors derive from the group of the magnesium and/or zinc salts and/or magnesium and/or zinc complexes.

The spectrum of zinc salts, by preference, those of organic acids, particularly preferably, of organic carboxylic acids, preferred according to the present invention extends from salts that are poorly soluble or insoluble in water, i.e., exhibit a solubility below 100 mg/l, by preference, below 10 mg/l, in particular, below 0.01 mg/l, to those salts that exhibit a solubility in water above 100 mg/l, by preference, above 500 mg/l, particularly preferably, above 1 g/l, and, in particular, above 5 g/l (all solubilities at a water temperature of 20° C.). Zinc citrate, zinc oleate, and zinc stearate, for example, belong to the first group of zinc salts; zinc formate, zinc acetate, zinc lactate, and zinc gluconate, for example, belong to the group of the soluble zinc salts.

At least one zinc salt of an organic carboxylic acid, particularly preferably, a zinc salt from the group of zinc stearate, zinc oleate, zinc gluconate, zinc acetate, zinc lactate, and/or zinc citrate, is used with particular preference as a glass corrosion inhibitor. Zinc ricinoleate, zinc abietate, and zinc oxalate are also preferred.

In the context of the present invention, the zinc salt content of cleaning agents is by preference between 0.1 and 5 wt %, preferably, between 0.2 and 4 wt %, and, in particular, between 0.4 and 3 wt %, or the concentration of zinc in oxidized form (calculated as Zn²⁺) is between 0.01 and 1 wt %, by preference, between 0.02 and 0.5 wt %, and, in particular, between 0.04 and 0.2 wt %, based in each case on the total weight of the glass-corrosion-inhibitor-containing agent.

The known substances of the existing art are usable as silver protection agents. In general, silver protection agents can be selected principally from the group of the triazoles, benzotriazoles, bisbenzotriazoles, aminotriazoles, alkylaminotriazoles, and transition-metal salts or complexes. It is particularly preferred to use benzotriazole and/or alkylaminotriazole. The 3-amino-5-alkyl-1,2,4-triazoles or their physiologically compatible salts are preferably used according to the present invention, these substances being used with particular preference at a concentration from 0.001 to 10 wt %, by preference, 0.0025 to 2 wt %, particularly preferably, 0.01 to 0.04 wt %. Preferred acids for salt formation are hydrochloric acid, sulfuric acid, phosphoric acid, carbonic acid, sulfurous acid, organic carboxylic acids such as acetic, glycolic, citric, succinic acid. 5-pentyl, 5-heptyl, 5-nonyl, 5-undecyl, 5-isononyl, 5-versatic-10 acid alkyl-3-amino-1,2,4-triazoles, and mixtures of these substances, are very particularly effective.

Moreover, cleaner formulations often contain agents containing active chlorine, which agents can greatly decrease the corrosion of silver surfaces. In chlorine-free cleaners, oxygen- and nitrogen-containing organic redox-active compounds are used, in particular, such as di- and trivalent phenols, e.g. hydroquinone, catechol, hydroxyhydroquinone, gallic acid, phloroglucine, pyrogallol, and derivatives of these classes of compounds. Salt-like and complex-like inorganic compounds, for example, salts of the metals Mn, Ti, Zr, Hf, V, Co, and Ce, are also often used. Preferred in this context are the transition-metal salts that are selected from the group of the manganese and/or cobalt salts and/or complexes, particularly preferably the cobalt(amine) complexes, cobalt(acetate) complexes, cobalt(carbonyl) complexes, the chlorides of cobalt or manganese, and manganese sulfate. Zinc compounds can likewise be used to prevent corrosion on the items being washed.

Instead of or in addition to the silver protection agents described above, for example, the benzotriazoles, redox-active substances can be used. These substances are preferably inorganic redox-active substances from the group of the manganese, titanium, zirconium, hafnium, vanadium, cobalt, and cerium salts and/or complexes, the metals preferably being present in one of the oxidation stages II, III, IV, V, or VI.

The metal salts or metal complexes that are used should be at least partially soluble in water. The counterions suitable for salt formation comprise all usual singly, doubly, or triply negatively charged inorganic anions, e.g., oxide, sulfate, nitrate, fluoride, but also organic anions such as, for example, stearate.

Particularly preferred metal salts and/or metal complexes are selected from the group of MnSO₄, Mn(II) citrate, Mn(II) stearate, Mn(II) acetyl acetonate, Mn(II)-[1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ and mixtures thereof, so that metal salts and/or metal complexes selected from the group of MnSO₄, Mn(II) citrate, Mn(II) stearate, Mn(II) acetyl acetonate, Mn(II) [1-hydroxyethane-1,1-diphosphonate], V₂O₅, V₂O₄, VO₂, TiOSO₄, K₂TiF₆, K₂ZrF₆, CoSO₄, Co(NO₃)₂, Ce(NO₃)₃ are used with particular preference.

The inorganic redox-active substances, in particular, metal salts or metal complexes, are preferably coated, i.e., completely covered with a material that is watertight but easily soluble at cleaning temperatures, in order to prevent their premature decomposition or oxidation during storage. Preferred coating materials, which are applied using known methods, e.g., Sandwik melt-coating methods from the food industry, are paraffins, microcrystalline waxes, waxes of natural origin such as carnauba wax, candelilla wax, beeswax, higher-melting-point alcohols such as, for example, hexadecanol, soaps, or fatty acids.

The aforesaid metal salts and/or metal complexes are contained in cleaning agents by preference, in a quantity from 0.05 to 6 wt %, by preference, 0.2 to 2.5 wt %, based in each case on the entire agent.

The bleach catalysts are bleach-enhancing transition-metal salts or transition-metal complexes such as, for example, Mn, Fe, Co, Ru, or Mo salt complexes or carbonyl complexes. Mn, Fe, Co, Ru, Mo, Ti, V, and Cu complexes having nitrogen-containing tripod ligands, as well as Co, Fe, Cu, and Ru amine complexes, are also applicable as bleach catalysts.

Bleach-enhancing transition-metal complexes, in particular, having the central atoms Mn, Fe, Co, Cu, Mo, V, Ti, and/or Ru, preferably selected from the group of the manganese and/or cobalt salts and/or complexes, particularly preferably the cobalt(amine) complexes, cobalt(acetate) complexes, cobalt(carbonyl) complexes, the chlorides of cobalt or manganese, and manganese sulfate, are preferred according to the present invention.

In order to counteract microorganisms, antimicrobial active substances can be used. A distinction is made here, in terms of the antimicrobial spectrum and mechanism of action, between bacteriostatics and bactericides, fungistatics and fungicides, etc. Important substances from these groups are, for example, benzalkonium chlorides, alkylarylsulfonates, halogen phenols, and phenol mercuric acetate; these compounds can also be entirely omitted.

The group of the polymers includes, in particular, the polymers having washing or cleaning activity, for example, the clear rinsing polymers and/or polymers effective as softeners. In addition to nonionic polymers, cationic, anionic, and amphoteric polymers are also generally usable in washing or cleaning agents.

“Cationic polymers” for purposes of the present invention are polymers that carry a positive charge in the polymer molecule. This can be implemented, for example, by way of (alkyl)ammonium groupings or other positively charged groups present in the polymer chain. Particularly preferred cationic polymers derive from the groups of the quaternized cellulose derivatives, the polysiloxanes having quaternary groups, the cationic guar derivatives, the polymeric dimethyldiallylammonium salts and their copolymers with esters and amides of acrylic acid and methacrylic acid, the copolymers of vinylpyrrolidone with quaternized derivatives of dialkylaminoacrylate and -methacrylate, the vinylpyrrolidone/methoimidazolinium chloride copolymers, the quaternized polyvinyl alcohols, or the polymers known by the INCI designations Polyquaternium 2, Polyquaternium 17, Polyquaternium 18, and Polyquaternium 27.

“Amphoteric polymers” for purposes of the present invention further comprise, in addition to a positively charged group in the polymer chain, negatively charged groups or monomer units. These groups can be, for example, carboxylic acids, sulfonic acids, or phosphonic acids.

Preferred washing or cleaning agents, in particular, preferred automatic dishwashing agents, are characterized in that they contain a polymer a) that comprises monomer units of the formula R¹R²C═CR³R⁴ in which each radical R¹, R², R³, R⁴ is selected, mutually independently, from hydrogen, a derivatized hydroxy group, C₁₋₃₀ linear or branched alkyl groups, aryl, aryl-substituted C₁₋₃₀ linear or branched alkyl groups, polyalkoxylated alkyl groups, heteroatomic organic groups having at least one positive charge without charged nitrogen, at least one quaternized nitrogen atom, or at least one amino group having a positive charge in the sub-range of the pH range from 2 to 11, or salts thereof, with the stipulation that at least one radical R¹, R², R³, R⁴ is a heteroatomic organic group having at least one positive charge without charged nitrogen, at least one quaternized nitrogen atom, or at least one amino group having a positive charge.

Cationic or amphoteric polymers that are particularly preferred in the context of the present Application contain as a monomer unit a compound of the general formula

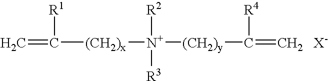

in which R¹ and R⁴, mutually independently, denote H or a linear or branched hydrocarbon radical having 1 to 6 carbon atoms; R² and R³, mutually independently, denote an alkyl, hydroxyalkyl, or aminoalkyl group in which the alkyl radical is linear or branched and comprises between 1 and 6 carbon atoms, this preferably being a methyl group; x and y, mutually independently, denote integers between 1 and 3. X⁻ represents a counterion, preferably a counterion from the group of chloride, bromide, iodide, sulfate, hydrogensulfate, methosulfate, lauryl sulfate, dodecylbenzenesulfonate, p-toluenesulfonate (tosylate), cumenesulfonate, xylenesulfonate, phosphate, citrate, formate, acetate, or mixtures thereof.

Preferred radicals R¹ and R⁴ in the above formula are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH.

Polymers that comprise a cationic monomer unit of the above general formula in which R¹ and R⁴ denote H, R² and R³ denote methyl, and x and y are each 1 are very particularly preferred. The corresponding monomer units of the formula

H₂C═CH—(CH₂)—N⁺(CH₃)₂—(CH₂)—CH═CH₂

X⁻

are also referred to, in the case in which X⁻=chloride, as DADMAC (diallyldimethylammonium chloride).

Further cationic or amphoteric polymers that are particularly preferred contain a monomer unit of the general formula

R¹HC═CR²—C(O)—NH—(CH₂)ₓ—N⁺R³R⁴R⁵

X⁻

in which R¹, R², R³, R⁴ and R⁵, mutually independently, denote a linear or branched, saturated or unsaturated alkyl or hydroxyalkyl radical having 1 to 6 carbon atoms, preferably a linear or branched alkyl radical selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH, and x denotes a whole number between 1 and 6.

Very particularly preferred in the context of the present Application are polymers that comprise a cationic monomer unit of the above general formula in which R¹ denotes H and R², R³, R⁴, and R⁵ denote methyl, and x denotes 3. The corresponding monomer units of the formula

H₂C═C(CH₃)—C(O)—NH—(CH₂)ₓ—N⁺(CH₃)₃

X⁻

are also referred to, in the case where X⁻=chloride, as MAPTAC (methacrylamidopropyltrimethylammonium chloride).

Polymers that contain, as monomer units, diallyldimethylammonium salts and/or acrylamidopropyltrimethylammonium salts are preferred for use according to the present invention.

The aforementioned amphoteric polymers comprise not only cationic groups but also anionic groups or monomer units. Anionic monomer units of this kind derive, for example, from the group of the linear or branched, saturated or unsaturated carboxylates, the linear or branched, saturated or unsaturated phosphonates, the linear or branched, saturated or unsaturated sulfates, or the linear or branched, saturated or unsaturated sulfonates. Preferred monomer units are acrylic acid, (meth)acrylic acid, (dimethyl)acrylic acid, (ethyl)acrylic acid, cyanoacrylic acid, vinylacetic acid, allylacetic acid, crotonic acid, maleic acid, fumaric acid, cinnamic acid, and their derivatives, the allylsulfonic acids such as, for example, allyloxybenzenesulfonic acid and methallylsulfonic acid, or the allylphosphonic acids.

Amphoteric polymers preferred for use derive from the group of the alkylacrylamide/acrylic acid copolymers, the alkylacrylamide/methacrylic acid copolymers, the alkylacrylamide/methylmethacrylic acid copolymers, the alkylacrylamide/acrylic acid/alkylaminoalkyl(meth)acrylic acid copolymers, the alkylacrylamide/methacrylic acid/alkylaminoalkyl(meth)acrylic acid copolymers, the alkylacrylamide/methylmethacrylic acid/alkylaminoalkyl(meth)acrylic acid copolymers, the alkylacrylamide/alkylmethacrylate/alkylaminoethylmethacrylate/alkylmethacrylate copolymers, and the copolymers of unsaturated carboxylic acids, cationically derivatized unsaturated carboxylic acids and, if applicable, further ionic or nonionogenic monomers.

Zwitterionic polymers preferred for use derive from the group of the acrylamidoalkyltrialkylammonium chloride/acrylic acid copolymers and their alkali and ammonium salts, the acrylamidoalkyltrialkylammonium chloride/methacrylic acid copolymers and their alkali and ammonium salts, and the methacroylethylbetaine/methacrylate copolymers.

Also preferred are amphoteric polymers that encompass, in addition to one or more anionic monomers, methacrylamidoalkyltrialkylammonium chloride and dimethyl(diallyl)ammonium chloride as cationic monomers.

Particularly preferred amphoteric polymers derive from the group of the methacrylamidoalkyltrialkylammonium chloride/dimethyl(diallyl)ammonium chloride/acrylic acid copolymers, the methacrylamidoalkyltrialkylammonium chloride/dimethyl(diallyl)ammonium chloride/methacrylic acid copolymers, and the methacrylamidoalkyltrialkylammonium chloride/dimethyl(diallyl)ammonium chloride/alkyl(meth)acrylic acid copolymers, as well as their alkali and ammonium salts.

Particularly preferred are amphoteric polymers from the group of the methacrylamidopropyltrimethylammonium chloride/dimethyl(diallyl)ammonium chloride/acrylic acid copolymers, the methacrylamidopropyltrimethylammonium chloride/dimethyl(diallyl)ammonium chloride/acrylic acid copolymers, and the methacrylamidopropyltrimethylammonium chloride/dimethyl(diallyl)ammonium chloride/alkyl(meth)acrylic acid copolymers, as well as their alkali and ammonium salts.

Polymers effective as softeners are, for example, the sulfonic acid group-containing polymers, which are used with particular preference.

Particularly preferred for use as sulfonic acid group-containing polymers are copolymers of unsaturated carboxylic acids, sulfonic acid group-containing monomers, and, if applicable, further ionic or nonionogenic monomers.

Preferred as monomers in the context of the present invention are unsaturated carboxylic acids of the formula

R¹(R²)C═C(R³)COOH,

in which R¹ to R³, mutually independently, denote —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms.

Among the unsaturated carboxylic acids that can be described by the above formula, acrylic acid (R¹═R²═R³═H), methacrylic acid (R¹═R²═H; R³═CH₃) and/or maleic acid (R¹═COOH; R²═R³═H) are particularly preferred.

Preferred among the sulfonic acid group-containing monomers are those of the formula

R⁵(R⁶)C═C(R⁷)—X—SO₃H,

in which R⁵ to R⁷, mutually independently, denote —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals substituted with —NH₂, —OH, or —COOH, or denote —COOH or —COOR⁴, R⁴ being a saturated or unsaturated, straight-chain or branched hydrocarbon radical having 1 to 12 carbon atoms, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—.

Among these monomers, those of the formulas

H₂C═CH—X—SO₃H

H₂C═C(CH₃)—X—SO₃H

HO₃S—X—(R⁶)C═C(R⁷)—X—SO₃H,

in which R⁶ and R⁷, mutually independently, are selected from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—, are preferred.

Particularly preferred sulfonic acid group-containing monomers in this context are 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, al lyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropylacrylate, 3-sulfopropylmethacrylate, sulfomethacrylamide, sulfomethylmethacrylamide, and water-soluble salts of the aforesaid acids.

Ethylenically unsaturated compounds, in particular, are suitable as further ionogenic or nonionogenic monomers. The concentration of these further ionogenic or nonionogenic monomers in the polymers that are used is by preference less than 20 wt %, based on the polymer. Polymers to be used in particularly preferred fashion are made up only of monomers of the formula R¹(R²)C═C(R³)COOH and monomers of the formula R⁵(R⁶)C═C(R⁷)—X—SO₃H.

In summary, copolymers of
i) unsaturated carboxylic acids of the formula

R¹(R²)C═C(R³)COOH

in which R¹ to R³, mutually independently, denote —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms,
ii) sulfonic acid group-containing monomers of the formula

R⁵(R⁶)C═C(R⁷)—X—SO₃H,

in which R⁵ to R⁷, mutually independently, denote —H, —CH₃, a straight-chain or branched saturated alkyl radical having 2 to 12 carbon atoms, a straight-chain or branched, mono- or polyunsaturated alkenyl radical having 2 to 12 carbon atoms, alkyl or alkenyl radicals as defined above substituted with —NH₂, —OH, or —COOH, or denote —COOH or —COOR⁴, R⁴ being a saturated or unsaturated, straight-chain or branched hydrocarbon radical having 1 to 12 carbon atoms; and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—,
iii) if applicable, further ionic or nonionogenic monomers,
   are particularly preferred.

Particularly preferred copolymers are made up of
i) one or more unsaturated carboxylic acids from the group of acrylic acid, methacrylic acid, and/or maleic acid;
ii) one or more sulfonic acid group-containing monomers of the formulas

H₂C═CH—X—SO₃H

H₂C═C(CH₃)—X—SO₃H

HO₃S—X—(R⁶)C═C(R⁷)—X—SO₃H

in which R⁵ and R⁷, are selected, mutually independently, from —H, —CH₃, —CH₂CH₃, —CH₂CH₂CH₃, —CH(CH₃)₂, and X denotes an optionally present spacer group that is selected from —(CH₂)ₙ— where n=0 to 4, —COO—(CH₂)ₖ— where k=1 to 6, —C(O)—NH—C(CH₃)₂—, and —C(O)—NH—CH(CH₂CH₃)—,
iii) if applicable, further ionic or nonionogenic monomers.

The copolymers can contain the monomers from groups i) and ii), and if applicable iii), in varying quantities, in which context all representatives of group i) can be combined with all representatives of group ii) and all representatives of group iii). Particularly preferred polymers exhibit certain structural units that are described below.

Preferred, for example, are copolymers that contain structural units of the formula

—[CH₂—CHCOOH]ₘ—[CH₂—CHC(O)—Y—SO₃H]ₚ—

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred.

These polymers are produced by copolymerization of acrylic acid with a sulfonic acid group-containing acrylic acid derivative. When the sulfonic acid group-containing acrylic acid derivative is copolymerized with methacrylic acid, a different polymer is arrived at, the use of which is likewise preferred. The corresponding copolymers contain structural units of the formula

—[CH₂—C(CH₃)COOH]ₘ—[CH₂—CHC(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred.

Entirely analogously, acrylic acid and/or methacrylic acid can also be copolymerized with sulfonic acid group-containing methacrylic acid derivatives, thereby modifying the structural units in the molecule. Copolymers that contain structural units of the formula

—[CH₂—CHCOOH]ₘ—[CH₂—C(CH₃)C(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred, are therefore preferred in just the same fashion as copolymers that contain structural units of the formula

—[CH₂—C(CH₃)COOH]ₘ—[CH₂—C(CH₃)C(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred.

Instead of acrylic acid and/or methacrylic acid or as a supplement thereto, maleic acid can also be used as a particularly preferred monomer of group i). This results in copolymers preferred according to the present invention that contain structural units of the formula

—[HOOCCH—CHCOOH]ₘ—[CH₂—CHC(O)—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred. Also preferred according to the present invention are copolymers that contain structural units of the formula

—[HOOCCH—CHCOOH]ₘ—[CH₂—C(CH₃)C(O)O—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)—.

In summary, those copolymers that contain structural units of the formulas

—[CH₂—CHCOOH]ₘ—[CH₂—CHC(O)—Y—SO₃H]ₚ—

—[CH₂—C(CH₃)COOH]ₘ—[CH₂—CHC(O)—Y—SO₃H]ₚ—

—[CH₂—CHCOOH]ₘ—[CH₂—C(CH₃)C(O)—Y—SO₃H]ₚ—,

—[CH₂—C(CH₃)COOH]ₘ—[CH₂—C(CH₃)C(O)—Y—SO₃H]ₚ—

—[HOOCCH—CHCOOH]ₘ—[CH₂—CHC(O)—Y—SO₃H]ₚ—

—[HOOCCH—CHCOOH]ₘ—[CH₂—C(CH₃)C(O)O—Y—SO₃H]ₚ—,

in which m and p each denote a natural integer between 1 and 2,000, and Y denotes a spacer group that is selected from substituted or unsubstituted aliphatic, aromatic, or substituted aromatic hydrocarbon radicals having 1 to 24 carbon atoms, spacer groups in which Y denotes —O—(CH₂)ₙ— where n=0 to 4, —O—(C₆H₄)—, —NH—C(CH₃)₂—, or —NH—CH(CH₂CH₃)— being preferred, are preferred according to the present invention.

The sulfonic acid groups can be present in the polymers entirely or partially in neutralized form, i.e., the acid hydrogen atom of the sulfonic acid group can be exchanged, in some or all sulfonic acid groups, for metal ions, preferably alkali-metal ions, and, in particular, sodium ions. The use of partially or entirely neutralized sulfonic acid group-containing copolymers is preferred according to the present invention.

The monomer distribution of the copolymers used in preferred fashion according to the present invention is, in copolymers that contain only monomers from groups i) and ii), by preference 5 to 95 wt % from each of i) and ii), particularly preferably, 50 to 90 wt % monomer from group i) and 10 to 50 wt % monomer from group ii), based in each case on the polymer.

For terpolymers, those that contain 20 to 85 wt % monomer from group i), 10 to 60 wt % monomer from group ii), and 5 to 30 wt % monomer from group iii), are particularly preferred.

The molar weight of the sulfo-copolymers used in preferred fashion according to the present invention can be varied in order to adapt the properties of the polymers to the desired application. Preferred washing or cleaning agents are characterized in that the copolymers have molar weights from 2,000 to 200,000 gmol⁻¹, by preference from 4,000 to 25,000 gmol⁻¹, and, in particular, from 5,000 to 15,000 gmol⁻¹.

The dosing devices according to the present invention can contain surfactants as a further active substance. In principle, all surfactants known to one skilled in the art, from the groups of the nonionic, anionic, cationic, or amphoteric surfactants, are suitable, although the nonionic surfactants are particularly preferred.

In a particularly preferred variant embodiment, the surfactants, in particular, the nonionic surfactants, are present in a form chemically bound to a carrier material. In such an embodiment, the surfactant can be released in the course of the washing or cleaning process, for example, by hydrolysis or oxidative cleavage of a chemical bond.

The active substances can be contained in the active substance preparations essentially in any quantities. Particularly preferred, however, are dosing devices in which the weight proportion of the active substance(s) accounts for 1 to 70 wt %, by preference 10 to 60 wt %, particularly preferably 20 to 50 wt %, in particular, 30 to 40 wt %, based in each case on the total weight of the active substance composition(s).

The dosing devices according to the present invention encompass at least two active substance compositions that differ from one another in terms of at least one of their ingredients.

In a first preferred embodiment, the two active substance compositions differ in terms of the carrier materials contained in them.

In a particularly preferred variant of this preferred embodiment of dosing devices according to the present invention, the two active substance compositions differ only in terms of the carrier materials contained, but not in terms of the active substances contained. The use of different carrier materials for the same active substance makes it possible advantageously to modify the release profile for that active substance and thus, for example, to extend the duration of action of the dosing device according to the present invention.

In a further particularly preferred embodiment of the dosing device according to the present invention, the two active substance compositions differ both in terms of one of the carrier materials contained in them and also in terms of at least one of the active substances contained in them.

Dosing devices according to the present invention, wherein at least two active substance compositions comprise different carrier materials, are preferred according to the present invention.

The dosing device can also come within the terms of one of claims 1 to 3, wherein all the active substance compositions comprise the same carrier materials.

Particularly preferred embodiments of dosing devices according to the present invention having two active substance compositions of differing composition are disclosed in TABLE 2 below:

| Active Substance Composition 1 | | Active Substance Composition 2 | |
|---|---|---|---|
| Carrier | Active | Carrier | Active |
| material | substance | material | substance |
| Organic polymer | Fragrance 1 | Organic polymer | Fragrance 2 |
| PEEA polymer | Fragrance 1 | PEEA polymer | Fragrance 2 |
| Organic polymer | Fragrance 1 | Organic or inorganic | Odor scavenger |
| | | carrier | |
| PEEA polymer | Fragrance 1 | Organic or inorganic | Odor scavenger |
| | | carrier | |
| Organic polymer | Fragrance 1 | Organic polymer | Glass corrosion |
| | | | inhibitor |
| PEEA polymer | Fragrance 1 | Organic polymer | Glass corrosion |
| | | | inhibitor |
| Organic polymer | Fragrance 1 | Inorganic carrier | Glass corrosion |
| | | | inhibitor |
| PEEA polymer | Fragrance 1 | Inorganic carrier | Glass corrosion |
| | | | inhibitor |
| Organic polymer | Fragrance 1 | Water-soluble glass | Glass corrosion |
| | | | inhibitor |
| PEEA polymer | Fragrance 1 | Water-soluble glass | Glass corrosion |
| | | | inhibitor |
| Organic polymer | Fragrance 1 | Organic polymer | Oxidation |
| | | | catalysts |
| PEEA polymer | Fragrance 1 | Organic polymer | Oxidation |
| | | | catalysts |
| Organic polymer | Fragrance 1 | Inorganic carrier | Oxidation |
| | | | catalysts |
| PEEA polymer | Fragrance 1 | Inorganic carrier | Oxidation |
| | | | catalysts |
| Organic polymer | Fragrance 1 | Water-soluble glass | Oxidation |
| | | | catalysts |
| PEEA polymer | Fragrance 1 | Water-soluble glass | Oxidation |
| | | | catalysts |
| Organic polymer | Fragrance 1 | Organic polymer | Surfactant |
| PEEA polymer | Fragrance 1 | Organic polymer | Surfactant |
| Organic polymer | Fragrance 1 | Inorganic carrier | Surfactant |
| PEEA polymer | Fragrance 1 | Inorganic carrier | Surfactant |
| Organic polymer | Fragrance 1 | Water-soluble glass | Surfactant |
| PEEA polymer | Fragrance 1 | Water-soluble glass | Surfactant |
| Organic polymer | Fragrance 1 | Organic polymer | Sulfopolymer |
| PEEA polymer | Fragrance 1 | Organic polymer | Sulfopolymer |
| Organic polymer | Fragrance 1 | Inorganic carrier | Sulfopolymer |
| PEEA polymer | Fragrance 1 | Inorganic carrier | Sulfopolymer |
| Organic polymer | Fragrance 1 | Water-soluble glass | Sulfopolymer |
| PEEA polymer | Fragrance 1 | Water-soluble glass | Sulfopolymer |
| Organic polymer | Fragrance 1 | Organic polymer | Disinfecting |
| | | | agent |
| PEEA polymer | Fragrance 1 | Organic polymer | Disinfecting |
| | | | agent |
| Organic polymer | Fragrance 1 | Inorganic carrier | Disinfecting |
| | | | agent |
| PEEA polymer | Fragrance 1 | Inorganic carrier | Disinfecting |
| | | | agent |
| Organic polymer | Fragrance 1 | Water-soluble glass | Disinfecting |
| | | | agent |
| PEEA polymer | Fragrance 1 | Water-soluble glass | Disinfecting |
| | | | agent |

The various active substance preparations of dosing devices according to the present invention can be present alongside one another, i.e., in direct contact with one another, in the container of the dosing device. In a further preferred embodiment, however, the dosing device comprises at least two, by preference three or four, receiving chambers separated from one another. Particularly preferred in this context are those dosing devices according to the present invention that comprise at least two receiving chambers, separated from one another, of which at least one receiving chamber at least in part surrounds at least one further receiving chamber. Particularly advantageous in this context are dosing devices that comprise a first receiving chamber in the form of a recess-shaped hollow body whose recess is closed off by a suitable closure element to form a further receiving chamber. Covers or independent containers are used with particular preference in this context as closure elements. The recess-shaped receiving chamber is joined to the cover or to the independent container, by preference, by means of an adhesive, latching, plug-in, or snap connection.

Particularly preferred embodiments of dosing devices according to the present invention having two receiving chambers are disclosed in TABLE 3 below:

| Receiving Chamber 1 | | Receiving Chamber 2 | |
|---|---|---|---|
| Carrier | Active | Carrier | Active |
| material | substance | material | substance |
| Organic polymer | Fragrance 1 | Organic polymer | Fragrance 2 |
| PEEA polymer | Fragrance 1 | PEEA polymer | Fragrance 2 |
| Organic polymer | Fragrance 1 | Organic or inorganic | Odor scavenger |
| | | carrier | |
| PEEA polymer | Fragrance 1 | Organic or inorganic | Odor scavenger |
| | | carrier | |
| Organic polymer | Fragrance 1 | Organic polymer | Glass corrosion |
| | | | inhibitor |
| PEEA polymer | Fragrance 1 | Organic polymer | Glass corrosion |
| | | | inhibitor |
| Organic polymer | Fragrance 1 | Inorganic carrier | Glass corrosion |
| | | | inhibitor |
| PEEA polymer | Fragrance 1 | Inorganic carrier | Glass corrosion |
| | | | inhibitor |
| Organic polymer | Fragrance 1 | Water-soluble glass | Glass corrosion |
| | | | inhibitor |
| PEEA polymer | Fragrance 1 | Water-soluble glass | Glass corrosion |
| | | | inhibitor |
| Organic polymer | Fragrance 1 | Organic polymer | Oxidation |
| | | | catalysts |
| PEEA polymer | Fragrance 1 | Organic polymer | Oxidation |
| | | | catalysts |
| Organic polymer | Fragrance 1 | Inorganic carrier | Oxidation |
| | | | catalysts |
| PEEA polymer | Fragrance 1 | Inorganic carrier | Oxidation |
| | | | catalysts |
| Organic polymer | Fragrance 1 | Water-soluble glass | Oxidation |
| | | | catalysts |
| PEEA polymer | Fragrance 1 | Water-soluble glass | Oxidation |
| | | | catalysts |
| Organic polymer | Fragrance 1 | Organic polymer | Surfactant |
| PEEA polymer | Fragrance 1 | Organic polymer | Surfactant |
| Organic polymer | Fragrance 1 | Inorganic carrier | Surfactant |
| PEEA polymer | Fragrance 1 | Inorganic carrier | Surfactant |
| Organic polymer | Fragrance 1 | Water-soluble glass | Surfactant |
| PEEA polymer | Fragrance 1 | Water-soluble glass | Surfactant |
| Organic polymer | Fragrance 1 | Organic polymer | Sulfopolymer |
| PEEA polymer | Fragrance 1 | Organic polymer | Sulfopolymer |
| Organic polymer | Fragrance 1 | Inorganic carrier | Sulfopolymer |
| PEEA polymer | Fragrance 1 | Inorganic carrier | Sulfopolymer |
| Organic polymer | Fragrance 1 | Water-soluble glass | Sulfopolymer |
| PEEA polymer | Fragrance 1 | Water-soluble glass | Sulfopolymer |
| Organic polymer | Fragrance 1 | Organic polymer | Disinfecting |
| | | | agent |
| PEEA polymer | Fragrance 1 | Organic polymer | Disinfecting |
| | | | agent |
| Organic polymer | Fragrance 1 | Inorganic carrier | Disinfecting |
| | | | agent |
| PEEA polymer | Fragrance 1 | Inorganic carrier | Disinfecting |
| | | | agent |
| Organic polymer | Fragrance 1 | Water-soluble glass | Disinfecting |
| | | | agent |

Further particularly preferred embodiments of dosing devices having three receiving chambers are disclosed in TABLE 4 below:

| Receiving Chamber 1 | | Receiving Chamber 2 | | Receiving Chamber 3 | |
|---|---|---|---|---|---|
| Carrier | Active | Carrier | Active | Carrier | Active |
| material | substance | material | substance | material | substance |
| Organic | Fragrance 1 | Organic | Fragrance 2 | Organic polymer | Fragrance 3 |
| polymer | | polymer | | | |
| PEEA | Fragrance 1 | PEEA | Fragrance 2 | PEEA polymer | Fragrance 3 |
| polymer | | polymer | | | |
| Organic | Fragrance 1 | Organic | Fragrance 2 | Organic or | Odor |
| polymer | | polymer | | inorganic carrier | scavenger |
| PEEA | Fragrance 1 | PEEA | Fragrance 2 | Organic or | Odor |
| polymer | | polymer | | inorganic carrier | scavenger |
| Organic | Fragrance 1 | Organic | Glass corrosion | Organic polymer | Surfactant |
| polymer | | polymer | inhibitor | | |
| PEEA | Fragrance 1 | Organic | Glass corrosion | Organic polymer | Surfactant |
| polymer | | polymer | inhibitor | | |
| Organic | Fragrance 1 | Inorganic | Glass corrosion | Organic polymer | Surfactant |
| polymer | | carrier | inhibitor | | |
| PEEA | Fragrance 1 | Inorganic | Glass corrosion | Organic polymer | Surfactant |
| polymer | | carrier | inhibitor | | |
| Organic | Fragrance 1 | Water-soluble | Glass corrosion | Organic polymer | Surfactant |
| polymer | | glass | inhibitor | | |
| PEEA | Fragrance 1 | Water-soluble | Glass corrosion | Organic polymer | Surfactant |
| polymer | | glass | inhibitor | | |
| Organic | Fragrance 1 | Organic | Glass corrosion | Organic polymer | Sulfopolymer |
| polymer | | polymer | inhibitor | | |
| PEEA | Fragrance 1 | Organic | Glass corrosion | Organic polymer | Sulfopolymer |
| polymer | | polymer | inhibitor | | |
| Organic | Fragrance 1 | Inorganic | Glass corrosion | Organic polymer | Sulfopolymer |
| polymer | | carrier | inhibitor | | |
| PEEA | Fragrance 1 | Inorganic | Glass corrosion | Organic polymer | Sulfopolymer |
| polymer | | carrier | inhibitor | | |
| Organic | Fragrance 1 | Water-soluble | Glass corrosion | Organic polymer | Sulfopolymer |
| polymer | | glass | inhibitor | | |
| PEEA | Fragrance 1 | Water-soluble | Glass corrosion | Organic polymer | Sulfopolymer |
| polymer | | glass | inhibitor | | |
| Organic | Fragrance 1 | Organic | Oxidation | Organic polymer | Surfactant |
| polymer | | polymer | catalysts | | |
| PEEA | Fragrance 1 | Organic | Oxidation | Organic polymer | Surfactant |
| polymer | | polymer | catalysts | | |
| Organic | Fragrance 1 | Inorganic | Oxidation | Organic polymer | Surfactant |
| polymer | | carrier | catalysts | | |
| PEEA | Fragrance 1 | Inorganic | Oxidation | Organic polymer | Surfactant |
| polymer | | carrier | catalysts | | |
| Organic | Fragrance 1 | Water-soluble | Oxidation | Organic polymer | Surfactant |
| polymer | | glass | catalysts | | |
| PEEA | Fragrance 1 | Water-soluble | Oxidation | Organic polymer | Surfactant |
| polymer | | glass | catalysts | | |
| Organic | Fragrance 1 | Organic | Oxidation | Organic polymer | Sulfopolymer |
| polymer | | polymer | catalysts | | |
| PEEA | Fragrance 1 | Organic | Oxidation | Organic polymer | Sulfopolymer |
| polymer | | polymer | catalysts | | |
| Organic | Fragrance 1 | Inorganic | Oxidation | Organic polymer | Sulfopolymer |
| polymer | | carrier | catalysts | | |
| PEEA | Fragrance 1 | Inorganic | Oxidation | Organic polymer | Sulfopolymer |
| polymer | | carrier | catalysts | | |
| Organic | Fragrance 1 | Water-soluble | Oxidation | Organic polymer | Sulfopolymer |
| polymer | | glass | catalysts | | |
| PEEA | Fragrance 1 | Water-soluble | Oxidation | Organic polymer | Sulfopolymer |
| polymer | | glass | catalysts | | |
| Organic | Fragrance 1 | Organic | Surfactant | Organic polymer | Sulfopolymer |
| polymer | | polymer | | | |
| PEEA | Fragrance 1 | Organic | Surfactant | Organic polymer | Sulfopolymer |
| polymer | | polymer | | | |
| Organic | Fragrance 1 | Inorganic | Surfactant | Organic polymer | Sulfopolymer |
| polymer | | carrier | | | |
| PEEA | Fragrance 1 | Inorganic | Surfactant | Organic polymer | Sulfopolymer |
| polymer | | carrier | | | |
| Organic | Fragrance 1 | Water-soluble | Surfactant | Organic polymer | Sulfopolymer |
| polymer | | glass | | | |
| PEEA | Fragrance 1 | Water-soluble | Surfactant | Organic polymer | Sulfopolymer |
| polymer | | glass | | | |
| Organic | Fragrance 1 | Organic | Sulfopolymer | Organic polymer | Disinfecting |
| polymer | | polymer | | | agent |
| PEEA | Fragrance 1 | Organic | Sulfopolymer | Organic polymer | Disinfecting |
| polymer | | polymer | | | agent |
| Organic | Fragrance 1 | Inorganic | Sulfopolymer | Inorganic carrier | Disinfecting |
| polymer | | carrier | | | agent |
| PEEA | Fragrance 1 | Inorganic | Sulfopolymer | Inorganic carrier | Disinfecting |
| polymer | | carrier | | | agent |
| Organic | Fragrance 1 | Water-soluble | Sulfopolymer | Water-soluble | Disinfecting |
| polymer | | glass | | glass | agent |
| PEEA | Fragrance 1 | Water-soluble | Sulfopolymer | Water-soluble | Disinfecting |
| polymer | | glass | | glass | agent |
| Organic | Fragrance 1 | Organic | Disinfecting agent | Organic polymer | Surfactant |
| polymer | | polymer | | | |
| PEEA | Fragrance 1 | Organic | Disinfecting agent | Organic polymer | Surfactant |
| polymer | | polymer | | | |
| Organic | Fragrance 1 | Inorganic | Disinfecting agent | Organic polymer | Surfactant |
| polymer | | carrier | | | |
| PEEA | Fragrance 1 | Inorganic | Disinfecting agent | Organic polymer | Surfactant |
| polymer | | carrier | | | |
| Organic | Fragrance 1 | Water-soluble | Disinfecting agent | Organic polymer | Surfactant |
| polymer | | glass | | | |
| PEEA | Fragrance 1 | Water-soluble | Disinfecting agent | Organic polymer | Surfactant |
| polymer | | glass | | | |

The dosing devices according to the present invention are suitable for dosing active substances having washing or cleaning activity in washing or cleaning processes. Washing or cleaning processes in which a dosing device according to the present invention is used for dosing active substances are, therefore, a further subject of the present Application, the use of dosing devices according to the present invention in automatic cleaning processes being particularly preferred.

Because of the special presentation of the active substances having washing or cleaning activity on special matched carrier materials, the dosing devices according to the present invention are particularly suitable for dosing active substances having washing or cleaning activity in the context of washing or cleaning processes in which the dosing device and the active substance compositions contained in it are heated to temperatures between 30 and 150° C. Processes for dosing active substances, wherein a dosing device according to the present invention is heated to temperatures between 30 and 150° C., are, therefore, preferred.

The dosing devices according to the present invention are used by preference in interiors of buildings, vehicles, or technical equipment. A process according to the present invention, wherein dosing of the active substances occurs in interiors of buildings, vehicles, or technical equipment is, therefore, preferred.

The dosing devices are used with particular preference in alternating-humidity spaces, i.e., in spaces having greatly fluctuating atmospheric humidity. The term “alternating-humidity spaces” refers, in particular, to the interiors of automatic dishwashers, textile washing machines, or textile dryers. A process according to the present invention, wherein dosing of the active substances occurs in interiors of textile washing machines, textile dryers, or automatic washing machines, is, therefore, preferred.

1. A dosing device for dosing active substances in washing or cleaning processes, encompassing a container and
a) a first active substance composition, present in said container, that contains at least one carrier material and at least one active substance; and
b) a second active substance composition, present in said container, that likewise contains at least one carrier material and at least one active substance, but differs in terms of at least one of its ingredients from the first active substance composition,
wherein the carrier material in at least one active substance composition is water-insoluble.

2. The dosing device according to claim 1, wherein the container is produced from a water-insoluble material.

3. The dosing device according to claim 1, wherein the container comprises at least two receiving chambers, separated from one another, which are each filled with at least one active substance composition, said active substance compositions differing at least in terms of one of their ingredients.

4. The dosing device according to claim 1, wherein at least two active substance compositions comprise different carrier materials.

5. The dosing device according to claim 1, wherein all the active substance compositions comprise the same carrier materials.

6. The dosing device according to claim 1, wherein all the carrier materials used are water-insoluble.

7. The dosing device according to claim 1, wherein the carrier material in at least one of the active substance compositions is present in particle form.

8. The dosing device according to claim 1, wherein at least one of the carrier materials is a polymer material.

9. The dosing device according to claim 8, wherein the polymeric carrier material contains at least 10 wt % ethylene-vinyl acetate copolymer.

10. The dosing device according to claim 1, wherein ethylene-vinyl acetate copolymer is used as a polymer carrier material, and said copolymer contains 5 to 50 wt % vinyl acetate based on the total weight of the copolymer.

11. The dosing device according to claim 1, wherein at least one polymeric carrier material has a melting or softening point between 40 and 125° C.

12. The dosing device according to claim 1, wherein at least one of the carrier materials is an inorganic carrier material.

13. The dosing device according to claim 1, wherein at least one of the active substances is selected from the group consisting of fragrances, fragrance scavengers, dyes, glass corrosion inhibitors, silver protection agents, bleach catalysts, antimicrobial active substances, germicides, fungicides, polymers having washing or cleaning activity, and surfactants and mixtures thereof.

14. The dosing device according to claim 1, wherein the weight proportion of the active substance(s) accounts for 1 to 70 wt %, based on the total weight of the active substance composition(s).

15. The dosing device according to claim 1, wherein the container is produced from a water-insoluble material selected from the group consisting of a textile material, a polymer and a polymer mixture.

16. The dosing device according to claim 1, wherein at least one of the carrier materials is a polymer selected from the group consisting of ethylene-vinyl acetate copolymers, low- or high-density polyethylene (LDPE, HDPE), polypropylene, polyethylene-polypropylene copolymers, polyether-polyamide block copolymers, styrene-butadiene (block) copolymers, styrene-isoprene (block) copolymers, styrene-ethylene-butylene copolymers, acrylonitrile-butadiene-styrene copolymers, acrylonitrile-butadiene copolymers, polyether esters, polyisobutene, polyisoprene, ethylene-ethyl acrylate copolymers, polyamides, polycarbonate, polyesters, polyacrylonitrile, polymethyl methacrylate, polyurethanes, polyvinyl alcohols and mixtures thereof.

17. A washing or cleaning process comprising a step of applying a dosage of washing or cleaning active substances to at least one article to be cleaned, the source of said dosage being a dosing device encompassing a container and
a) a first active substance composition, present in said container, that contains at least one carrier material and at least one active substance; and
b) a second active substance composition, present in said container, that likewise contains at least one carrier material and at least one active substance, but differs in terms of at least one of its ingredients from the first active substance composition,
wherein the carrier material in at least one active substance composition is water-insoluble.

18. The process according to claim 17, wherein the dosing device is heated to temperatures between 30 and 150° C.

19. The process according to claim 17, wherein the dosing of active substances is effected in interiors of buildings, vehicles, or technical equipment, interiors of textile washing machines, textile dryers, or dish washing machines.

20. A washing or cleaning process for automatic dishwashing or clothes washing machines, the process comprising the step of applying a dosage of washing or cleaning active substances to an article to be cleaned, the source of the dosage being a dosing device encompassing a container and
a) a first active substance composition, present in said container, that contains at least one carrier material and at least one active substance; and
b) a second active substance composition, present in said container, that likewise contains at least one carrier material and at least one active substance, but differs in terms of at least one of its ingredients from the first active substance composition,
wherein the carrier material in at least one active substance composition is water-insoluble.
